(19) United States
(12) Patent Application Publication
(10) Pub. No.: US 2009/0065638 A1
(43) Pub. Date: Mar. 12, 2009

(54) Apparatus for voice communication between persons inside and persons outside an aircraft

(76) Inventors: Isaiah Watas Cox, Baltimore, MD (US); Todd Tripp, Fort St. John (CA)

Correspondence Address: Borealis Technical Limited, 23545 NW Skyline Blvd, North Plains, OR, 97133-9204, US

(21) Appl. No.: 12/220,597

(22) Filed: Jul. 24, 2008

Related U.S. Application Data
(63) Continuation-in-part of application No. 12/217,358, filed on Jul. 3, 2008.
Application No. 12/217,358 is a continuation-in-part of application No. 12/217,635, filed on Jul. 7, 2008.
Application No. 12/217,635 is a continuation-in-part of application No. PCT/US2007/019054, filed on Aug. 29, 2007.
Application No. PCT/US2007/019054 is a continuation-in-part of application No. PCT/US2007/019054, filed on Aug. 29, 2007.
Application No. PCT/US2007/019054 is a continuation-in-part of application No. PCT/US2007/019054, filed on Aug. 29, 2007.
(60) Provisional application No. 60/961,940, filed on Jul. 24, 2007.
(60) Provisional application No. 60/958,602, filed on Jul. 5, 2007.
(60) Provisional application No. 60/958,602, filed on Jul. 5, 2007.
(60) Provisional application No. 60/958,601, filed on Jul. 5, 2007.
(60) Provisional application No. 60/958,602, filed on Jul. 5, 2007.
(60) Provisional application No. 60/958,602, filed on Jul. 5, 2007.

(30) Foreign Application Priority Data
Aug. 29, 2006 (GB) 0616984.1

(51) Int. Cl. B64D 47/00; B64C 25/50; B64D 31/14; H04B 1/44; B64C 25/42

(52) U.S. Cl. 244/1 R; 244/50; 244/53 R; 244/110 A; 455/78

(57) ABSTRACT

An apparatus for facilitating voice communication between persons outside an aircraft and persons inside an aircraft, is disclosed, comprising: an external control unit comprising: voice sensing means; transmitting means for transmitting voice information to persons in said aircraft; receiving means for receiving voice information from persons in said aircraft; and amplifying means for enabling said voice information to be heard; and an in-aircraft control unit comprising: voice sensing means; transmitting means for transmitting voice information to persons external to said aircraft; receiving means for receiving voice information from persons external to said aircraft; and amplifying means for enabling said voice information to be heard.

### CROSS-REFERENCE TO RELATED APPLICATIONS

This application claims the benefit of U.S. Provisional Patent Application No. 60/961,940, filed Jul. 24, 2007. This application is a Continuation-in-Part of U.S. patent application Ser. No. 12/217,635 filed Jul. 7, 2008, which application claims the benefit of U.S. Provisional Patent Application No. 60/958,602, filed Jul. 5, 2007, and is a Continuation-in-Part of International Application PCT/US2007/019054, filed Aug. 29, 2007, and which designates the United States, which international application was published on Apr. 24, 2008, as International Publication WO08048393 in the English language. International Application No. PCT/US2007/019054 claims the benefit of GB Patent Application No. 0616984.1 filed on Aug. 29, 2006, and of U.S. Provisional Patent Application No. 60/958,602 filed on Jul. 5, 2007. This application is a Continuation-in-Part of U.S. patent application Ser. No. 12/217,358 filed 3 Jul. 2008, which application claims the benefit of U.S. Provisional Patent Application No. 60/958,601, filed Jul. 5, 2007, and is a Continuation-in-Part of International Application PCT/US2007/019054, filed Aug. 29, 2007, and which designates the United States, which international application was published on Apr. 24, 2008, as International Publication WO08048393 in the English language. International Application No. PCT/US2007/019054 claims the benefit of GB Patent Application No. 0616984.1 filed on Aug. 29, 2006, and of U.S. Provisional Patent Application No. 60/958,602 filed on Jul. 5, 2007. This application is a Continuation-in-Part of International Application PCT/US2007/019054, filed Aug. 29, 2007, and which designates the United States, which international application was published on Apr. 24, 2008, as International Publication WO08048393 in the English language. International Application No. PCT/US2007/019054 claims the benefit of GB Patent Application No. 0616984.1 filed on Aug. 29, 2006, and of U.S. Provisional Patent Application No. 60/958,602 filed on Jul. 5, 2007.

### BACKGROUND OF THE INVENTION

French Patent No. 2815217 to Weiss discloses equipment for ground based aircraft/transport management comprising a fixed management centre in radio telephone communication with mobile units for the purpose of sending and receiving task lists between the management centre and ground staff. The data can be received by the ground staff in the form of text on a screen or in the form of voice communication.

Apparatus for enabling voice communication between aircraft passengers and ground based callers is known in the art, for example U.S. Pat. No. 5,438,610 to Bhagat which discloses a ground-to-air telephone calling system including a computer for receiving an airborne telephone number and a call-back number from a calling party and forming the telephone numbers into a data signal comporting with existing protocol filed in the FCC, an uplink unit for uplinking the data signal to a satellite and a plurality of downlink stations for receiving the data signal from the satellite; a plurality of ground stations corresponding to each of the downlink units for receiving the data signals and passing a call signal identifying the airborne telephone and particular ground station to a corresponding transmit/receive unit for subsequent transmission to the aircraft; a call being initiated from the ground station to the calling party over the public switched telephone network if the aircraft responds to the call signal.

Apparatus for enabling voice communication between a pilot in the air and Air Traffic Control towers are known in art, for example U.S. Pat. No. 6,313,759 to Musland-Sipper, which discloses a system for communicating between an aircraft and a ground control station. The system includes a communications module disposed onboard the aircraft and capable of electronically communicating with the ground control station. The communications module includes an input interface that permits an operator onboard the aircraft to view messages that are sent and received from the ground control station. The input interface has a plurality of display configurations for the viewing and entry of information. The input interface permits data relevant to a flight of the aircraft to be entered by the operator while viewing at least one of the plurality of display configurations.

Motors providing high torque at low speeds are known in the art. Specifically, such motors are known that are designed for the purpose of propelling aircraft on the ground.

WO05/12584 to Edelson discloses a motor-generator machine comprising a slotless AC induction motor. The motor disclosed therein is an AC induction machine comprising an external electrical member attached to a supporting frame and an internal electrical member attached to a supporting core; one or both supports are slotless, and the electrical member attached thereto comprises a number of surface mounted conductor bars separated from one another by suitable insulation. An airgap features between the magnetic portions of core and frame. Electrical members perform the usual functions of rotor and stator but are not limited in position by the present invention to either role. The stator comprises at least three different electrical phases supplied with electrical power by an inverter. The rotor has a standard winding configuration, and the rotor support permits axial rotation.

WO2006002207 to Edelson discloses a motor-generator machine comprising a high phase order AC machine with short pitch winding. Disclosed therein is a high phase order alternating current rotating machine having an inverter drive that provides more than three phases of drive waveform of harmonic order H, and characterized in that the windings of the machine have a pitch of less than 180 rotational degrees. Preferably the windings are connected together in a mesh, star or delta connection. The disclosure is further directed to selection of a winding pitch that yields a different chording factor for different harmonics. The aim is to select a chording factor that is optimal for the desired harmonics.

Disclosed in WO2006/065988 to Edelson is a motor-generator machine comprising stator coils wound around the inside and outside of a stator, that is, toroidally wound. The machine may be used with a dual rotor combination, so that both the inside and outside of the stator may be active. Even order drive harmonics may be used, if the pitch factor for the windings permits them. In a preferred embodiment, each of the coils is driven by a unique, dedicated drive phase. However, if a number of coils have the same phase angle as one another, and are positioned on the stator in different poles, these may alternatively be connected together to be driven by the same drive phase. In a preferred embodiment, the coils are connected to be able to operate with 2 poles, or four poles, under H=1 where H is the harmonic order of the drive waveform. The coils may be connected together in series, parallel, or anti-parallel.

In U.S. patent application Ser. No. 11/403,402, filed Apr. 12, 2006, a motor-generator machine is disclosed comprising a polyphase electric motor which is preferably connected to drive systems via mesh connections to provide variable V/Hz ratios. The motor-generator machine disclosed therein comprises an axle; a hub rotatably mounted on said axle; an electrical induction motor comprising a rotor and a stator; and an inverter electrically connected to said stator; wherein one of said rotor or stator is attached to said hub and the other of said rotor or stator is attached to said axle. Such a machine may be located inside a vehicle drive wheel, and allows a drive motor to provide the necessary torque with reasonable system mass.

International Appl. No. PCT/US2006/12483, filed Apr. 5, 2006, discloses a motor-generator machine comprising an induction and switched reluctance motor designed to operate as a reluctance machine at low speeds and an inductance machine at high speeds. The motor drive provides more than three different phases and is capable of synthesizing different harmonics. As an example, the motor may be wound with seven different phases, and the drive may be capable of supplying fundamental, third and fifth harmonic. The stator windings are preferably connected with a mesh connection. The system is particularly suitable for a high phase order induction machine drive systems of the type disclosed in U.S. Pat. Nos. 6,657,334 and 6,831,430. The rotor, in combination with the stator, is designed with a particular structure that reacts to a magnetic field configuration generated by one drive waveform harmonic. The reaction to this harmonic by the rotor structure produces a reluctance torque that rotates the rotor. For a different harmonic drive waveform, a different magnetic field configuration is produced, for which the rotor structure defines that substantially negligible reluctance torque is produced. However, this magnetic field configuration induces substantial rotor currents in the rotor windings, and the currents produce induction based torque to rotate the rotor.

### BRIEF SUMMARY OF THE INVENTION

It is an object of the invention to take advantage of the new, quieter airport tarmac conditions made possible by the use of self-propelled aircraft undercarriages.

It is a further object of the invention to enable voice communication between persons inside and persons outside an aircraft.

It is a yet further object of the invention to provide a control unit which combines voice communication with other aircraft control functions.

An apparatus for facilitating voice communication between persons outside an aircraft and persons inside an aircraft, is disclosed, comprising: an external control unit comprising: voice sensing means; transmitting means for transmitting voice information to persons in said aircraft; receiving means for receiving voice information from persons in said aircraft; and amplifying means for enabling said voice information to be heard; and an in-aircraft control unit comprising: voice sensing means; transmitting means for transmitting voice information to persons external to said aircraft; receiving means for receiving voice information from persons external to said aircraft; and amplifying means for enabling said voice information to be heard.

### BRIEF DESCRIPTION OF THE SEVERAL VIEWS OF THE DRAWING

The invention will now be described in detail with reference to the following drawing in which:

FIG. 1 shows a ground-end control unit and user.

FIG. 2 shows a pilot-end control unit and user.

### DETAILED DESCRIPTION OF THE INVENTION

An apparatus for facilitating voice communication between persons outside an aircraft and persons inside an aircraft, is disclosed, comprising: an external control unit comprising: voice sensing means; transmitting means for transmitting voice information to persons in said aircraft; receiving means for receiving voice information from persons in said aircraft; and amplifying means for enabling said voice information to be heard; and an in-aircraft control unit comprising: voice sensing means; transmitting means for transmitting voice information to persons external to said aircraft; receiving means for receiving voice information from persons external to said aircraft; and amplifying means for enabling said voice information to be heard.

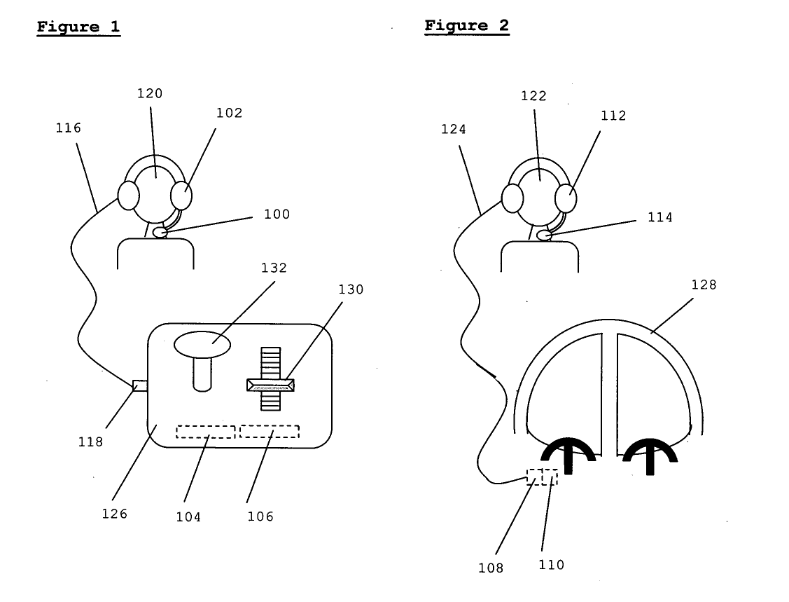

FIG. 1 shows the preferred embodiment of the apparatus in which the further optional features of direction and speed control are present, as will be described. FIG. 1 shows external control unit 126 with person 120 outside said aircraft, who is preferably an airport staff member. External control unit 126 comprises a jack 118 for ground-end wire 116. Wire 116 connects ground-end headphones 102 (the amplifying means of said external control unit) and ground-end microphone (the voice-sensing means of said external control unit) 100 to external control unit 126. Headphones 102 and microphone 100 are worn by airport staff member 120 for communication with persons in said aircraft. External control unit 126 further comprises ground-end transmitting means 104 and ground-end receiving means 106, which may be a combined transmitting and receiving means as will be described later. In the figure shown, external control unit 126 comprises the further optional features of direction control arm 132 and speed control slider 130. Although these are not necessary features of the invention, they are preferred and are therefore pictured here.

FIG. 1 further shows a person 122 in said aircraft, who is preferably the pilot, wearing pilot-end headphones 112 (the amplifying means of said in-aircraft control unit) and pilot-end microphone 114 (the voice-sensing means of said in-aircraft control unit), connected via pilot-end wire 124 to pilot-end transmitting means 108 and pilot-end receiving means 110, which are located in cockpit 128.

Said external control unit is a handheld or fixed console constructed from plastic, metal, or any material suitable for use outside in all weather conditions, in which is located the ground-end equipment for speaking and listening, as well as possibly other controls used by persons outside an aircraft. Preferably, the unit is attached to the ground or mounted on equipment attached to the ground, near a gate at an airport. An advantage of this is that it will always be at a known location. Said control unit may also be attached to any airport gate equipment such as a passenger loading bridge or other portable gate equipment. An advantage of this is that said control unit can be moved to a gate at which it is required. Said control unit may also be attached to a maintenance hanger, a runway, a taxiway, an apron or other location where aircraft need to be moved, or attached to any equipment in such areas. Said control unit may also be handheld. An advantage of this is that the airport staff member can move about freely while wearing said amplification means and voice sensing means. Furthermore, said amplification means and voice sensing means may be wireless (i.e. there is no ground-end wire 116) and may communicate with said external control unit via infrared, Bluetooth, ultrasound, optical, laser, radio, radar or any known wireless communication method. This also has the advantage of the airport staff member being able to move freely, while retaining the advantages mentioned earlier of having a fixed control unit.

Said external control unit may further comprise a voice-sensing means on/off control, and/or an amplification means on/off control, either or both of which may be a push button, switch, lever, or any other means for sending an on or an off signal. Alternatively, there may be a control which switches between voice-sensing means use and amplifying means use, i.e. between speaking and listening, similar to a walkie talkie. Alternatively, there may be a control which switches on/off both amplifying means and voice sensing means concurrently. The external control unit may further comprise an indicator or indicators for showing whether said amplifying means and voice sensing means are on or off. This may be an LED, other light, LCD display or any other known form of indicator.

Said external control unit may further comprise one or more of parking brake control means, APU control means, direction control means and speed control means.

Said brake control means and said APU control means, if present, may be switches, levers, push buttons, sliders, touch pads, optical sensors, heat sensors, pedals or any other type of control means capable of transmitting an on and an off signal. Said brake control means and said APU control means may be situated on said external control means, on the outside of said aircraft, fixed to gate, maintenance hangar, or other aircraft equipment, or in another location.

Said direction control means and speed control means, if present, may be an arm comparable to a joystick. Said arm may be rigid and able to be pushed to cause the aircraft to decelerate and pulled to cause the aircraft to accelerate. The aircraft will move in a direction determined by the direction in which the arm is moved by the person outside said aircraft holding the arm, at a speed determined by the person outside said aircraft pushing or pulling the arm. Alternatively, said arm is a flexible strap, rope, chain or any other flexible control arm made from any strong, flexible material or a rigid material in a flexible form such as a metal chain. In this variation, speed and direction are determined by the speed and direction respectively in which the airport ground staff member moves said arm. Alternatively, there may be a separate control for speed which may be a slider, dial, two-way switch or any other control means capable of indicating a multiplicity of levels of speed. The arm may only move the aircraft when it is held taut, and a safety feature may cut off communications between the arm and the aircraft when said arm becomes not taut. Alternatively, position sensors at the end of said arm may determine the movements of said arm to control the aircraft, whether said arm is taut or loose. Said arm protrudes from said external control unit and is movably attached to said control unit in a manner similar to a the stick of a joystick from its base, such that said control unit can interpret movements of said arm in order to transmit them to said aircraft nosewheel. Preferably, said control unit can recognize directional movements of said arm in at least two dimensions. An advantage of this is that the movement of the aircraft can be controlled very intuitively by a ground staff member moving the arm in the direction the aircraft is desired to be moved. Alternatively, said control unit can recognize directional movements of said arm in only one dimension. Advantages of this are that the apparatus is less expensive and easier to produce and that there is less information to transmit to said nosewheel. In this variation, left and right movements could be controlled via said arm, while forward/reverse motion of the aircraft is controlled by a separate control or by a distinct movement of said arm, for example pushing or pulling said arm.

Said external control unit may further comprise control means for controlling any other aircraft function, for example but without limitation, aileron movement, windscreen wiper operation, fuel tank opening, door opening, emergency stop, fire suppression, etc. Such functions may be useful for maintenance, repair, emergency or other situations.

Said external control unit may further comprise a security cover for preventing unauthorized use, which covers some or all of the control means on said external control means (which may include microphone, headphone, speed control, direction control APU control, brake control or any other controls present) or restricts their movement, whereby said control means cannot be accessed or operated without a physical key, electronic key, number code, letter code, fingerprint recognition, iris recognition, barcode recognition, or any other known means for unlocking a cover.

Said external control unit may comprise a transmittal-restricting safety feature whereby operations of one or both of said control means are not transmitted to said nosewheel unless said transmittal-restricting safety feature has been disabled. Said feature may be disabled using a physical key, electronic key, number code, letter code, fingerprint recognition; iris recognition, barcode recognition or any other known means of safety feature disabling.

Said in-aircraft control unit, comprising voice sensing means, transmitting means, receiving means and amplifying means, is preferably built into the cockpit in the control/display area but may be a stand alone unit to be placed in said cockpit or elsewhere in said aircraft, or may be built into another section of said aircraft, for example, the kitchen if it will be used to communicate with food loading staff, etc. Existing aircraft transmitting and receiving means, located in the aircraft cockpit or elsewhere, may be adapted to transmit and receive the voice signals of the present invention in place of said transmitting and receiving means.

Said pilot-end and ground-end transmitting means may be any known form of transmitter, transponder, transceiver or other information communicating means. Preferably said information is transmitted wirelessly between persons outside said aircraft and those inside, for example via infrared, optical, laser, Bluetooth, radio, radar or any other known wireless information transmittal means. An advantage of this is that no wire has to be attached, detached or stored. Alternatively said information is transmitted using electric cables, optical cables, or any other known form of wire. A wire may be detachable at one or both ends, that is, the aircraft end and the external control unit end. An advantage of this is that a reliable connection is always maintained.

Said pilot-end and ground-end receiving means may be a direct conversion receiver or any known form of receiver, transponder, transceiver or other known form of information receiving means.

Said pilot-end transmitting means and said pilot-end receiving means may be combined in a single unit. Said ground-end transmitting means and said ground-end receiving means may be combined in a single unit.

Said ground-end amplifying means are preferably headphones and are more preferably over-ear headphones as shown in FIG. 1, which may include noise canceling technology, sound isolation, and any or all technology known in the art for enhancing headphone sound quality. An advantage of this is that voice communication from said headphones can be easily heard and unnecessary background noise can be very effectively removed. A further advantage is that, since airport ground staff commonly wear headphones for the purposes of ear protection, the wearing of headphones will be familiar and the procedural change small. Said headphones may have a feature whereby the user can alternate between isolating and hearing outside sound. Said ground-end amplifying means may alternatively be in-ear headphones or earplugs, or may be hookable headphones which hook onto or around the ear in the manner of a Bluetooth headset for a mobile phone, or may attach to the ear in any other way. Such smaller earpieces or headphones are a possibility around quieter self-propelled aircraft which taxi without turbines, where ear protection is not needed. An advantage of smaller earpieces or headphones is that they are lighter and easier to wear. A further advantage is that they allow sounds to be heard from the direct environment of the persons outside the aircraft using the headphones, which facilitates communication and personal safety. There may be two earpieces, one for each ear, or there may be one earpiece for attachment to one ear only. As a further alternative, said ground-end amplifying means may be a loudspeaker in or close to said external control unit, such that voice communication from said loudspeaker can be heard a small distance from said external control unit. An advantage of this is that no headphones have to be worn, so that the person outside the aircraft has more freedom of movement and can hear sounds in their direct environment, increasing personal safety and ease of communication with other persons outside said aircraft. Said ground-end amplifying means may be connected via a wire to the external control unit as shown in FIG. 1 or may be wireless, using Bluetooth, infrared, ultrasound, radio, laser, or any other wireless technology.

Said pilot-end amplifying means are preferably headphones and are more preferably over-ear headphones as shown in FIG. 1, and may include noise canceling technology, sound isolation, and any or all technology known in the art for enhancing headphone sound quality. An advantage of this is that voice communication from said headphones can be easily heard and unnecessary background noise can be very effectively removed. A further advantage is that, since pilots commonly wear headphones, the wearing of headphones will be familiar and the procedural change small. Said headphones may in fact be the regular cockpit headphones, configured to receive voice signals from said pilot-end receiving means as well as all the signals usually received by existing cockpit headphones. Said headphones may have a feature whereby the user can alternate between isolating and hearing outside sound, and/or between hearing sound from ground staff and other sources. Said pilot-end amplifying means may alternatively be in-ear headphones or earplugs, or may hook onto or around the ear in the manner of a Bluetooth headset for a mobile phone, or may attach to the ear in any other way. Such smaller earpieces or headphones are a possibility in aircraft where headphones are not otherwise worn. An advantage of smaller earpieces or headphones is that they are lighter and easier to wear. A further advantage is that they allow sounds to be heard from the direct environment of the user, which facilitates communication and personal safety. There may be two earpieces, one for each ear, or there may be one earpiece for attachment to one ear only. As a further alternative, said pilot-end amplifying means may be a loudspeaker in said cockpit, such that voice communication from said loudspeaker can be heard in said cockpit. An advantage of this is that no headphones have to be worn, so that the user has more freedom of movement and can hear sounds in their direct environment, increasing personal safety and ease of communication with other persons outside said aircraft. Said pilot-end amplifying means may be connected via a wire to the cockpit as shown in FIG. 1 or may be wireless, using Bluetooth, infrared, ultrasound, radio, laser, or any other wireless technology.

Said ground- and pilot-end amplifying means may also be any other known form of amplifying means.

Said ground-end voice-sensing means is preferably a microphone which preferably extends from said ground-end headphones as shown in FIG. 1, but may also hang from an earpiece which hooks onto or sits inside an ear, or may clip onto the user's clothes, or may be embedded in or close to said external control unit, or be shaped and located in any other way. Said ground-end voice-sensing means may also be any other means for sensing and enabling the transmission of a voice signal.

Said pilot-end voice-sensing means is preferably a microphone which preferably extends from said pilot-end headphones as shown in FIG. 1, but may also hang from an earpiece which hooks onto or sits inside an ear, or may clip onto the user's clothes, or may be embedded in or close to the controls area of said cockpit, or be shaped and located in any other way.

Said pilot-end voice-sensing means may also be any other means for sensing and enabling the transmission of a voice signal.

Said person inside said aircraft is preferably the pilot but may also be other members of aircraft crew such as a co-pilot, air hostesses, passengers, cleaning staff.

Said person outside said aircraft is preferably a member of airport ground staff responsible for supervising the parking of the aircraft, but may also be ground staff responsible for fuel loading, passenger loading, baggage loading, cargo loading, fuel loading, cleaning, maintenance, repair, or any other ground function, or may be air traffic controllers, any other airport staff, emergency medical staff, passengers' acquaintances or business contacts, or persons needing or desiring to communicate with said aircraft.

1. An apparatus for facilitating voice communication between persons outside an aircraft and persons inside an aircraft, comprising: an external control unit comprising: voice sensing means; transmitting means for transmitting voice information to persons in said aircraft; receiving means for receiving voice information from persons in said aircraft; and amplifying means for enabling said voice information to be heard; and an in-aircraft control unit comprising: voice sensing means; transmitting means for transmitting voice information to persons external to said aircraft; receiving means for receiving voice information from persons external to said aircraft; and amplifying means for enabling said voice information to be heard.

2. The apparatus of claim 1 wherein said aircraft has a self-propulsion unit in the nosewheel and said external control unit further comprises: a control arm for inputting the required direction of movement of said nosewheel; means for transmitting direction information to said self-propelled nosewheel; the apparatus further comprising: means for receiving direction information at said self-propelled nosewheel; and means for controlling the direction of said nosewheel; whereby airport staff can control the movements of said aircraft by moving said arm in the direction of required movement of said aircraft.

3. The apparatus of claim 1 wherein said aircraft has a self-propulsion unit in the nosewheel and said external control unit further comprises: control means for inputting the required speed of said nosewheel; means for transmitting speed information to said self-propelled nosewheel; the apparatus further comprising: means for receiving speed information at said self-propelled nosewheel; and means for controlling the speed of said nosewheel.

4. The apparatus of claim 1 wherein said aircraft has an APU and said external control unit further comprises: control means for turning on and off said APU; and transmitting means for transmitting information to said APU; the apparatus further comprising: receiving means for receiving information at said APU.

5. The apparatus of claim 1 wherein said aircraft has parking brakes and said external control unit further comprises: control means for applying and releasing the parking brakes of said aircraft; and transmitting means for transmitting information to the parking brakes of said aircraft; the apparatus further comprising receiving means for receiving information at the parking brakes of said aircraft.

6. The apparatus of claim 1 wherein said external control unit further comprises control means for controlling one or more selected from the list comprising: aileron movement, windscreen wiper operation, fuel tank opening, door opening, emergency stop, fire suppression, a further function of said aircraft.

7. The apparatus of claim 1 wherein said external control unit is constructed from material suitable for use outside in all weather conditions.

8. The apparatus of claim 1 wherein said external control unit one selected from the list comprising: attached to the ground, handheld, mounted on portable airport equipment, mounted on fixed aircraft equipment.

9. (canceled)

10. (canceled)

11. The apparatus of claim 1 wherein said external control unit is at a location selected from the list comprising gate, maintenance hangar, runway, taxiway, apron, other location to where aircraft movement is required.

12. The apparatus of any claim 1 wherein said voice sensing means and said amplifying means communicate with said external control unit by a means selected from the list comprising: by a wire, wirelessly.

13. (canceled)

14. The apparatus of claim 1 wherein said external control unit further comprises at least one on/off control for operating at least one selected from the list comprising: said voice sensing means, said amplification means.

15. (canceled)

16. (canceled)

17. The apparatus of claim 1 wherein said external control unit further comprises at least one indicator for indicating the operation of at least one selected from the list comprising: said amplifying means, said voice sensing means.

18. (canceled)

19. The apparatus of claim 1 wherein said external control unit further comprises a feature selected from the list comprising: security cover, transmittal restricting safety feature.

20. (canceled)

21. The apparatus of claim 1 wherein said in-aircraft control unit is one selected from the list comprising: built into said cockpit, a stand-alone unit, built into a part of said aircraft.

22. (canceled)

23. (canceled)

24. The apparatus of claim 1 wherein said pilot-end transmitting means is the existing aircraft transmitting means adapted to transmit voice signals of the present invention.

25. The apparatus of claim 1 wherein said pilot-end receiving means is the existing aircraft receiving means adapted to receive voice signals of the present invention.

26. The apparatus of claim 1 wherein said transmitting means and said receiving means communicate by a means selected from the list comprising: wirelessly, via a wire, via a wire which is detachable at one or both ends.

27. (canceled)

28. (canceled)

29. The apparatus of claim 1 wherein said receiving means are one selected from the list comprising: receiver, transponder, transceiver.

30. The apparatus of claim 1 wherein said transmitting means are one selected from the list comprising: transmitter, transponder, transceiver.

31. The apparatus of claim 1 wherein said ground-end transmitting means and said ground-end receiving means are combined in a single unit.

32. The apparatus of claim 1 wherein said pilot-end transmitting means and said pilot-end receiving means are combined in a single unit.

33. The apparatus of claim 1 wherein said amplifying means are one selected from the list comprising: headphones, over-ear headphones, in-ear headphones, earplugs, hookable headphones, loudspeaker.

34. The apparatus of claim 1 wherein said amplifying means are connected in a way selected from the list comprising: wirelessly, via a wire.

35. The apparatus of claim 1 wherein said amplifying means are positioned in a manner selected from the list comprising: in one ear of user, in two ears of user, remote from user.

36. The apparatus of claim 1 wherein said pilot-end amplifying means are the regular cockpit headphones adapted to receive the voice signals of the present invention as well as all signals usually received by existing cockpit headphones.

37. The apparatus of claim 1 wherein said voice-sensing means is one selected from the list comprising: microphone extending from headphones, microphone hanging from earpiece, microphone clipped to user's person, microphone embedded in control unit.

38. The apparatus of claim 1 wherein said person inside said aircraft is one selected from the list comprising: pilot, co-pilot, air host/ess, passenger, cleaning staff.

39. The apparatus of claim 1 wherein said person outside said aircraft is one selected from the list comprising: ground staff member responsible for supervising the parking of the aircraft, ground staff member responsible for fuel loading, ground staff member responsible for passenger loading, ground staff member responsible for baggage loading, ground staff member responsible for cargo loading, ground staff member responsible for fuel loading, ground staff member responsible for cleaning, ground staff member responsible for maintenance, ground staff member responsible for repair, ground staff member responsible for any other ground function, air traffic controllers, other airport staff, emergency medical staff, passengers' acquaintances, passengers' business contacts, persons desiring to communicate with said aircraft.
